(19) United States
(12) Patent Application Publication
(10) Pub. No.: US 2025/0018680 A1
(43) Pub. Date: Jan. 16, 2025

(54) SURFACE PROTECTING FILM

(71) Applicant: Toray Advanced Film Co., Ltd., Tokyo (JP)

(72) Inventors: Norihide Inoue, Takatsuki-shi, Osaka (JP); Yuuka Tomita, Takatsuki-shi, Osaka (JP)

(73) Assignee: Toray Advanced Film Co., Ltd., Tokyo (JP)

(21) Appl. No.: 18/713,469

(22) PCT Filed: Dec. 1, 2022
(86) PCT No.: PCT/JP2022/044323

§ 371 Date: May 24, 2024

(30) Foreign Application Priority Data
Dec. 9, 2021 (JP) 2021-199778

(51) Int. Cl. B32B 3/30; B32B 27/08; B32B 27/32

(52) U.S. Cl. CPC B32B 3/30; B32B 27/08; B32B 27/32; B32B 2250/242; B32B 2307/538; B32B 2551/00

(57) ABSTRACT

A surface protection film is disclosed, comprising a back face layer, an intermediate layer, and an adhesive layer, all constructed from polypropylene or polyethylene based resins. The back face layer features a surface with an arithmetic average roughness (Ra) of 0.5 μm or less, a ten point average roughness (Rz) ranging from 2 to 8 μm, and a periodic protrusion height not exceeding 9 μm. The adhesive layer surface exhibits an arithmetic average roughness (Ra) of 0.3 μm or less, a ten point average roughness (Rz) between 0.5 and 4 μm, and a maximum fisheye height of 1.5 μm or less, providing enhanced protection and durability for various surfaces.

### CROSS REFERENCE TO RELATED APPLICATIONS

This application is a US national stage filing under 35 U.S.C. § 371 of International Application No. PCT/JP2022/044323, filed Dec. 1, 2022, which claims priority to Japanese Patent Application No. 2021-199778, filed Dec. 9, 2021, each of which is incorporated herein by reference in its entirety.

### TECHNICAL FIELD

This disclosure relates primarily to a surface protection film to use for components of optical products.

### BACKGROUND

Surface protection films are now used for the protection of optical products such as optical films and sheets. These surface protection films used in optical products are required not to cause the contamination of adherends. In addition, when a surface protection film is attached to a adherend such as optical film, protrusion defectives in an adhesive layer or back face originating in the surface protection film, which may be attributable to fisheyes etc. in the surface protection film, or protrusions formed by external contaminants coming from the environment can be transferred to the adherend under stress generated by the attaching force or stress due to the tightening of the wound film that occurs during storage of the roll, which can lead to the problems of dents, deformations, and other indentations as well as transfer defects and, therefore, surface protection films are strongly required not to cause the formation of these indentations and transfer defects.

Moreover, surface protection films are also required to possess rigidity because, when processed into rolls, they should be free of creasing caused by winding, sagging, and surface irregularities and should maintain good appearance.

These requirements have become increasingly stringent in recent years, and now there are strong demands for surface protection films that do not suffer dents, deformations, other indentations, or transfer defects even when attached to an adherend, wound into a roll, and stored for an extended period as a wound film roll.

Under such circumstances, with the aim of preventing the formation of such dents etc. (indentations and transfer defects) on an adherend from being caused by fisheyes and other protrusion defects, there have been some proposed solutions such as the use of a substrate made of a polyethylene based resin produced with a metallocene catalyst while conforming to a specific requirement for cross fractionation extraction percentage (Japanese Unexamined Patent Publication (Kokai) No. HEI 9-111208) and the use of a polypropylene based resin polymerized with a metallocene catalyst (Japanese Unexamined Patent Publication (Kokai) No. 2009-143215). However, these solutions are not satisfactory enough to eliminate the problem with the formation indentations on adherends caused by minute fisheyes.

Another study has proposed a surface protection film with a surface having a specific texture that is produced by a special type film-forming nip roller (International Publication WO 2013/80925). Nevertheless, this technique cannot work effectively in preventing the formation of indentations from being caused by minute fisheyes and back face protrusions.

Under such circumstances, there has been a need for a solution that is effective in realizing both the elimination of indentations caused by minute fisheyes and back face protrusions and improvement in easy unwinding.

It could therefore be helpful to provide a surface protection film that works without causing an increase in adhesive strength and without causing contamination on the adherend or forming indentations such as dents and deformations of the adherend or transfer defects when it is attached to an optical film or sheet-like adherend, particularly an optical film such as polarizing plate or retardation phase difference plate that has to meet high level quality requirements including the prevention of indentations, deformations, etc., of the adherend from being formed as a result of minute fisheyes, back face protrusions, other similar defects, or creases caused during winding of the film.

### SUMMARY

We found that indentations or transfer defects can be reduced by developing a surface texture using a film-forming nip roller for a film of a specific type polyolefin.

We thus provide:

The surface protection film is a surface protection film including at least a back face layer, an intermediate layer, and an adhesive layer, wherein the back face layer, the intermediate layer, and the adhesive layer are each made of a polypropylene based resin or a polyethylene based resin, the surface of the back face layer having an arithmetic average roughness (Ra) of 0.5 μm or less, a ten point average roughness (Rz) of 2 to 8 μm, and a periodic protrusion height of 9 μm or less and the surface of the adhesive layer having an arithmetic average roughness (Ra) of 0.3 μm or less, a ten point average roughness (Rz) of 0.5 to 4 μm, and a maximum fisheye height of 1.5 μm or less.

If the technique described is applied to a film of a specific type polyolefin, a special surface texture can be formed by a film-forming nip roller to serve for the reduction of indentations or transfer defects.

### DETAILED DESCRIPTION

The surface protection film includes at least a back face layer, an intermediate layer, and an adhesive layer.

The back face layer of the surface protection film is made of a generally known polypropylene based resin or polyethylene based resin, and the back face layer has an arithmetic average roughness (Ra) of 0.5 μm or less, preferably 0.4 μm or less, a ten point average roughness (Rz) of 2 to 8 μm, preferably 2.5 to 7 μm, and a periodic protrusion height of 9 μm or less, preferably 7 μm or less. There are no specific limitations on the types of polypropylene based resin and polyethylene based resin as long as they satisfy the above requirements for Ra, Rz, and periodic protrusion height. Preferable examples include high-pressure low-density polyethylene, linear low-density polyethylene, and blends thereof, and the use of a linear low-density polyethylene with a density of 0.910 to 0.930 (g/cm³) is more preferable. It is still more preferable to adopt a linear low-density polyethylene with an MFR (measured at 190° C., hereinafter denoted as MFR(190)) of 1 to 7 g/10 min and a density of 0.915 to 0.930 (g/cm³). If they are in these preferable ranges, a desired back face texture and periodic protrusion height can be realized when processed with a film-forming nip roller, and this is advantageous for suppressing the formation of indentations on the adherend that is attributable to the periodic protrusion height.

The intermediate layer of the surface protection film is made of a polypropylene based resin, high-density polyethylene, high-pressure low-density polyethylene, or a blend thereof. A preferable example is a blend of a high-density polyethylene and a high-pressure low-density polyethylene. It is more preferable to adopt a blend of a high-density polyethylene with an MFR(190) of 3 to 12 g/10 min and a density of 0.950 to 0.970 (g/cm³) and a high-pressure low-density polyethylene with an MFR(190) of 1 to 7 g/10 min and a density of 0.915 to 0.930 (g/cm³). When such a high-density polyethylene and a high-pressure low-density polyethylene are blended, it is preferable to control the blend ratio of the high-density polyethylene to the high-pressure low-density polyethylene at 95:5 to 60:40 (by mass). If the intermediate layer has features in these preferable ranges, it is advantageous because it serves to ensure good film-forming property, higher thickness accuracy, and a decrease in the maximum height of the adhesive layer that is attributable to fisheyes when processing with a film-forming nip roller.

When the surface protection film is used in the intermediate layer as self-recovered, small amounts of the linear low-density polyethylene used in the back face layer and adhesive layer may be added thereto unless it causes deterioration in film properties.

The adhesive layer of the surface protection film is made of a generally known polypropylene based resin or polyethylene based resin. It is preferably made of a high-pressure low-density polyethylene, a linear low-density polyethylene, or a blend thereof. It is more preferable to use a linear low-density polyethylene with a density of 0.910 to 0.930 (g/cm³). It is still more preferable to adopt a so-called “non-metallocene” linear low-density polyethylene produced with a Ziegler based catalyst and having an MFR(190) of 1 to 7 g/10 min and a density of 0.915 to 0.930 (g/cm³). If they are in these preferable ranges, it is advantageous because it serves to prevent changes in adhesive strength after heating and pressurization, ensure stable adhesiveness, and reduce the maximum adhesive layer height attributable to fisheyes that may be caused during working with a film-forming nip roller. The maximum adhesive layer height attributable to fisheyes is 1.5 μm or less, preferably 1.0 μm or less. In addition, the adhesive layer of the protection film has an arithmetic average roughness (Ra) of 0.3 μm or less, preferably 0.2 μm or less, and has a ten point average roughness (Rz) of 0.5 to 4 μm, preferably 0.8 to 3.5 μm. If the adhesive layer has roughness features in these ranges, it serves to suppress the transfer of film surface texture.

For the surface protection film, it is preferable to impart an embossed texture on one side (surface) of the surface protection film using a film-forming nip roller. There are no specific limitations on the film-forming nip roller to use as long as it serves to form a surface texture suitable for the surface protection film according to the present invention and, for example, the film-forming nip rollers disclosed in International Publication WO 2013/80925 and Japanese Unexamined Patent Publication (Kokai) No. 2020-55189 can be used preferably. More specifically, it is preferable to adopt an embossing nip roller that has an arithmetic average roughness Ra of 0.2 μm or less, a ten point average roughness Rz of 2 to 8 μm, and an average surface irregularity interval Sm of 90 μm or less.

For the surface protection film, it is preferable to form an embossed texture on the back face thereof using a film-forming nip roller. We found that defects on the film-forming nip roller are likely to cause periodic defects on the back face of the surface protection film in relation to the rotation of the roller, and if the back face has high defects, they can cause indentations on the adherend when the film is attached to it. In addition, if fisheyes are present in the film, they are likely protrude into the adhesive layer, and if they have a large maximum height, they are likely to cause indentations on the adherend in a similar way.

The surface protection film is preferable since the use of a specific type nip roller and a specific combination of resin components will make it possible to suppress the formation of periodic defect heights on the back face thereof and reduce the maximum adhesive layer height attributable to fisheyes, thereby serving to decrease the number of indentations formed on the adherend.

To produce the surface protection film, good methods include, for example, a process in which a film prepared by T-die molding or inflation molding is reheated and nipped with the aforementioned nip roller and a process in which molten resin extruded from a T-die in a T-die molding step is nipped with a cooling roll and the aforementioned nip roller. It is preferable to adopt a process in which a mirror finished cooling roll with a surface roughness of 0.2 s or less is used in combination with the aforementioned film-forming nip roller to nip molten resin extruded from a T-die. A more preferable process uses a mirror finished cooling roll with a surface roughness of 0.15 s or less in combination with the aforementioned film-forming nip roller to nip molten resin extruded from a T-die.

A surface protection film that includes a back face layer, an intermediate layer, and an adhesive layer as described above is used since such a film can be easily wound off during its unwinding in the step in which it is attached to an adherend and also because it is highly uniform in thickness and accordingly realizes high handleability and high processability in the step for attaching it to the adherend. In particular, we can provide, with high reproducibility, a surface protection film that is free of dents, deformations, indentations, transfer, contamination, etc., on the adherend that are attributable to the maximum fisheye height, periodic protrusion height on the back face, various types of creases on the film, etc., which represent major features required of optical films such as polarizing plates and phase difference plates.

For the surface protection film, it is preferable that the back face layer has a thickness of 0.3 to 30 μm, preferably 0.5 to 20 μm, and more preferably 0.7 to 15 μm, that the intermediate layer has a thickness of 3 to 200 μm, preferably 5 to 150 μm, and more preferably 7 to 100 μm, and that the adhesive layer has a thickness of 0.3 to 30 μm, preferably 0.5 to 20 μm, and more preferably 0.7 to 15 μm.

The total thickness is of 3.6 to 260 μm, preferably 6 to 190 μm, and more preferably 8.4 to 130 μm, for example.

### EXAMPLES

The surface protection film will now be illustrated in detail below with reference to examples, although this disclosure should not be construed as being limited to these examples. Measurements and evaluations were made by using the methods described below.

### (1) Melt Flow Rate

Using a melt indexer manufactured by Toyo Seiki Seisaku-sho, Ltd. according to JIS K 7210-1997, measurements were taken at a temperature of 230° C. and a load of 2.16 kg for polypropylene based resin and at a temperature of 190° C. and a load of 2.16 kg for polyethylene based resin. All measurements are represented in grams per 10 minutes.

### (2) Surface Roughness

An automatic fine geometry measurement device (SURFCORDER ET4000A, manufactured by Kosaka Laboratory Ltd.) was used according to JIS B0601-1982 to take 10 measurements at 4 mm measuring intervals in the film's width direction (TD direction of the film) and at 10 μm intervals in the length direction (machine direction), followed by carrying out three dimensional analysis to determine the arithmetic average roughness (Ra), ten point average roughness (Rz), and average surface irregularity interval (measured in μm). The measuring conditions included the use of a diamond needle with a stylus tip radius of 2.0 μm and an apex angle of 60°, a measuring force of 100 μN, and a cut-off of 0.8 mm.

### (3) Adhesive Strength

Test pieces were prepared and each of them was adhered to an acrylic resin plate with a thickness of 2 mm and a width of 50 mm using a pasting pressure of 9,100 N/m and a pasting speed of 300 cm/min. One of them was stored for 24 hours in a 23° C. atmosphere and another was left to stand for 3 days at 50° C. in an oven and then taken out and stored for 24 hours in a 23° C. atmosphere. Their adhesive strength was measured using a tensile tester, in which the surface protection film was peeled off at a peeling speed of 300 mm/min and a peeling angle of 180°.

### (4) Evaluation for Transfer of Surface Texture

Evaluation for Transfer of Surface Texture from Film Pasted to Polyethylene Terephthalate (PET) Film

Polyester film of Lumirror (registered trademark) #50-U483 manufactured by Toray Industries, Inc., was used as the PET film to be pasted. Using a special pressurizing roller manufactured by Yasuda Seiki Seisakusho Ltd., each test specimen was pasted with a pasting pressure of 9,100 N/m and a pasting speed of 300 cm/min, cut to a size of 100 mm×100 mm, sandwiched between smooth plates, and stored at 60° C. for 24 hours, followed by peeling off the surface protection film and observing the contrast on the surface of the PET film under reflected light.

### Criteria Lv: Sensory Evaluation

1: No transfer can be observed.
2: Indistinct transfer can be observed.
3: Clear transfer can be observed.

### (5) Periodic Protrusion Defects and Periodic Protrusion Height

White light was applied to the surface protection film through the adhesive layer and the back face of the surface protection film was observed visually (transmission test). Defects causing light transmission and periodicity located defects were identified and the height of each defect on the back face was measured using a laser microscope.

### (6) Maximum Fisheye Height

White light was applied to the surface protection film through the adhesive layer and the adhesive layer was observed to identify protrusion defects (reflection test). The maximum height of each defect identified on the adhesive layer was measured in a measuring field of 550 μm×615 μm under a laser microscope. In this observation, when, for example, ten defects were identified, the height of the highest defect was adopted as the maximum fisheye height.

### (7) Thickness Variation R in TD Direction

The thickness of the film was measured at ten points in the TD direction using a dial gage. A value calculated by the following formula was taken as the thickness variation R (%).

Thickness variation R (%)=(((maximum thickness)−(minimum thickness))/(average thickness))×100

### Example 1

A non-metallocene linear low-density polyethylene with a density of 0.922 g/cm³ and an MFR(190) of 5.0 g/10 min was used as resin for the back face layer; a blend of 80 mass % high-density polyethylene with a density of 0.961 g/cm³ and an MFR(190) of 7.5 g/10 min and 20 mass % high-pressure low-density polyethylene with a density of 0.924 g/cm³ and an MFR(190) of 5.8 g/10 min was used for the intermediate layer; and a non-metallocene linear low-density polyethylene with a density of 0.922 g/cm³ and an MFR(190) of 5.0 g/10 min was used for the adhesive layer. A T-die type composite film production machine having a die width of 1,800 mm and containing three extruders each with a diameter of 65 mm (for back face layer), a diameter of 65 mm (for adhesive layer), or a diameter of 100 mm (for intermediate layer) was adopted, and the resin compositions prepared above were fed separately to the aforementioned extruders while the discharge rate of each extruder was adjusted so that the back face layer thickness proportion, the adhesive layer thickness proportion, and the intermediate layer thickness proportion would be 25%, 25%, and 50%, respectively, and then they were extruded through the T-die at an extrusion temperature of 220° C., quenched to 30° C. as they were nipped between a nip roller as specified in Japanese Unexamined Patent Publication (Kokai) No. 2020-55189 and a cast drum with a surface roughness of 0.1 s, and wound up to form a roll, thus providing a three layered film with a film thickness of 30 μm.

The back face of the surface protection film obtained above had an arithmetic average roughness (Ra) of 0.3 μm, a ten point average roughness (Rz) of 2.8 μm, and an average irregularity interval (Sm) of 40 μm while the adhesive layer had an arithmetic average roughness (Ra) of 0.1 μm and a ten point average roughness (Rz) of 0.7 μm. In addition, one periodic protrusion defect was found and the periodic protrusion height was 5.0 μm. The maximum height of the adhesive layer attributable to fisheyes was 0.8 μm.

In addition, the surface protection film obtained above had an adhesive strength at 23° C. of 0.04 N/50 mm. After being stored for 3 days at 50° C. in a pasted state, it had an adhesive strength of 0.04 N/50 mm. The thickness variation R ((maximum−minimum)/average) in the TD direction was 0.5%.

The film pasted to PET film was evaluated in film surface texture transfer test, and results showed that it was rated as Lv1.

### Example 2

Except that a high-pressure low-density polyethylene with a density of 0.923 g/cm³ and an MFR(190) of 5.0 g/10 min was used as resin for both the back face layer and the adhesive layer, the same procedure as in Example 1 was carried out to prepare a three layered film.

The back face of the surface protection film obtained above had an arithmetic average roughness (Ra) of 0.4 μm, a ten point average roughness (Rz) of 3.0 μm, and an average irregularity interval of 42 μm while the adhesive layer had an arithmetic average roughness (Ra) of 0.1 μm and a ten point average roughness (Rz) of 0.7 μm. In addition, two periodic protrusion defects were found and the periodic protrusion height was 4.8 μm. The maximum height of the adhesive layer attributable to fisheyes was 0.9 μm.

In addition, the surface protection film obtained above had an adhesive strength at 23° C. of 0.02 N/50 mm. After being stored for 3 days at 50° C. in a pasted state, it had an adhesive strength of 0.03 N/50 mm. The thickness variation R ((maximum−minimum)/average) in the TD direction was 0.5%.

The film pasted to PET film was evaluated in film surface texture transfer test, and results showed that it was rated as Lv1.

### Example 3

Except that a blend of 80 mass % high-density polyethylene with a density of 0.956 g/cm³ and an MFR(190) of 7.0 g/10 min and 20 mass % high-pressure low-density polyethylene with a density of 0.924 g/cm³ and an MFR(190) of 5.8 g/10 min was used for the intermediate layer, the same procedure as in Example 1 was carried out to prepare a three layered film.

The back face of the surface protection film obtained above had an arithmetic average roughness (Ra) of 0.3 μm, a ten point average roughness (Rz) of 2.7 μm, and an average irregularity interval (Sm) of 40 μm while the adhesive layer had an arithmetic average roughness (Ra) of 0.1 μm and a ten point average roughness (Rz) of 0.7 μm. In addition, no periodic protrusion defects were found, and the maximum height of the adhesive layer attributable to fisheyes was 0.5 μm.

In addition, the surface protection film obtained above had an adhesive strength at 23° C. of 0.05 N/50 mm. After being stored for 3 days at 50° C. in a pasted state, it had an adhesive strength of 0.05 N/50 mm. The thickness variation R ((maximum−minimum)/average) in the TD direction was 0.5%.

The film pasted to PET film was evaluated in film surface texture transfer test, and results showed that it was rated as Lv1.

### Comparative Example 1

Except for using an embossing nip roller with an arithmetic average roughness Ra of 0.5 μm, a ten point average roughness Rz of 9 μm, and an average surface irregularity interval Sm of 120 μm, the same procedure as in Example 1 was carried out to prepare a three layered film.

The back face of the surface protection film obtained above had an arithmetic average roughness (Ra) of 0.6 μm, a ten point average roughness (Rz) of 11.0 μm, and an average irregularity interval (Sm) of 140 μm while the adhesive layer had an arithmetic average roughness (Ra) of 0.2 μm and a ten point average roughness (Rz) of 1.0 μm. In addition, 30 periodic protrusion defects were found and the maximum height was 11 μm. The maximum height of the adhesive layer attributable to fisheyes was 1.7 μm.

In addition, the surface protection film obtained above had an adhesive strength at 23° C. of 0.04 N/50 mm. After being stored for 3 days at 50° C. in a pasted state, it had an adhesive strength of 0.04 N/50 mm. The thickness variation R ((maximum−minimum)/average) in the TD direction was 0.5%.

The film pasted to PET film was evaluated in film surface texture transfer test, and results showed that it was rated as Lv3.

### Comparative Example 2

Except that, instead of the use of an embossing nip roller, an air chamber was installed in which the material was cooled by applying air pressure to bring it into contact with a cast drum with a surface roughness of 3 s, the same procedure as in Example 1 was carried out to prepare a three layered film.

The back face of the surface protection film obtained above had an arithmetic average roughness (Ra) of 0.3 μm and a ten point average roughness (Rz) of 3.2 μm while the adhesive layer had an arithmetic average roughness (Ra) of 0.6 μm and a ten point average roughness (Rz) of 4.2 μm. No periodic protrusion defects were found. The maximum height of the adhesive layer attributable to fisheyes was 9.2 μm.

In addition, the surface protection film obtained above had an adhesive strength at 23° C. of 0.08 N/50 mm. After being stored for 3 days at 50° C. in a pasted state, it had an adhesive strength of 0.13 N/50 mm. The thickness variation R ((maximum−minimum)/average) in the TD direction was 0.7%.

The film pasted to PET film was evaluated in film surface texture transfer test, and results showed that it was rated as Lv3.

TABLE 1

| | Back face layer | | | | | | | |
|---|---|---|---|---|---|---|---|---|
| | | arithmetic | ten-point | average | | | | |
| | | average | average | irregularity | periodic | periodic | | |
| | | roughness | roughness | interval | protrusion | protrusion | Intermediate | |
| | | (Ra) | (Rz) | (Sm) | defects | height | layer | Adhesive layer |
| | resin | μm | μm | μm | number | μm | resin | resin |
| Example 1 | n- | 0.3 | 2.8 | 40 | 1 | 5.0 | HDPE + | n- |
| | LLDPE | | | | | | LDPE | LLDPE |
| Example 2 | LDPE | 0.4 | 3.0 | 42 | 2 | 4.8 | HDPE + | LDPE |
| | | | | | | | LDPE | |
| Example 3 | n- | 0.3 | 2.7 | 40 | 0 | — | HDPE + | n- |
| | LLDPE | | | | | | LDPE | LLDPE |
| Comparative | n- | 0.6 | 11.0 | 140 | 30 | 11.0 | HDPE + | n- |
| Example 1 | LLDPE | | | | | | LDPE | LLDPE |
| Comparative | n- | 0.3 | 3.2 | — | 0 | — | HDPE + | n- |
| Example 2 | LLDPE | | | | | | LDPE | LLDPE |

| | | | | | | Thickness | |
|---|---|---|---|---|---|---|---|
| | | | | | | variation R | |
| | Adhesive layer | | | | | in TD | |
| | arithmetic | ten-point | | Adhesive strength | | direction | |
| | average | average | maximum | | 50° C. | (maximum- | |
| | roughness | roughness | fisheye | | for | minimum)/ | Transfer |
| | (Ra) | (Rz) | height | 23° C. | 3 days | average | evaluation |
| | μm | μm | μm | N/50 mm | N/50 mm | % | Lv |
| Example 1 | 0.1 | 0.7 | 0.8 | 0.04 | 0.04 | 0.5 | 1 |
| Example 2 | 0.1 | 0.7 | 0.9 | 0.02 | 0.03 | 0.5 | 1 |
| Example 3 | 0.1 | 0.7 | 0.5 | 0.05 | 0.05 | 0.5 | 1 |
| Comparative | 0.2 | 1.0 | 1.7 | 0.04 | 0.04 | 0.5 | 3 |
| Example 1 | | | | | | | |
| Comparative | 0.6 | 4.2 | 9.2 | 0.08 | 0.13 | 0.7 | 3 |
| Example 2 | | | | | | | |

n-LLDPE: non-metallocene linear low-density polyethylene
HDPE: high-density polyethylene
LDPE: high-pressure low-density polyethylene

1. A surface protection film comprising at least a back face layer, an intermediate layer, and an adhesive layer, wherein the back face layer, the intermediate layer, and the adhesive layer are each made of a polypropylene based resin or a polyethylene based resin,
the surface of the back face layer having an arithmetic average roughness (Ra) of 0.5 μm or less, a ten point average roughness (Rz) of 2 to 8 μm, and a periodic protrusion height of 9 μm or less, and
the surface of the adhesive layer having an arithmetic average roughness (Ra) of 0.3 μm or less, a ten point average roughness (Rz) of 0.5 to 4 μm, and a maximum fisheye height of 1.5 μm or less. 1.
